(19) United States
(12) Patent Application Publication
(10) Pub. No.: US 2015/0363823 A1
(43) Pub. Date: Dec. 17, 2015

(54) SYSTEM AND METHOD FOR DETERMINING ASSOCIATIONS BETWEEN USERS AND MULTIPLE COMMUNICATION DEVICES

(71) Applicant: Run, Inc., New York, NY (US)

(72) Inventors: Michael A. Placentra, II, Hoboken, NJ (US); Christopher Outram, Bellerose, NY (US); Michael Celona, Palisades, NY (US); John Alexander Farrill, Brooklyn, NY (US); Mario Andres Morales, Jersey City, NJ (US)

(21) Appl. No.: 14/736,242

(22) Filed: Jun. 10, 2015

Related U.S. Application Data
(60) Provisional application No. 62/010,704, filed on Jun. 11, 2014.

(51) Int. Cl. G06Q 30/02; G06F 17/30

(52) U.S. Cl. CPC G06Q 30/0246; G06F 17/30516; G06F 17/30864

(57) ABSTRACT

In accordance with a method for determining a likelihood that two or more communication devices are associated with a common user, clickstream data from a plurality of clickstream events is received from each of a plurality of communication devices in response to a web page being loaded by each of the communication devices. The clickstream events received over a period of time are arranged into a datastream such that each of the datastreams contains clickstream events from only a single communication device. Based on the clickstream data in the clickstream events, potentially matching pairs of datastreams are identified that contain clickstream events from a common user using different communication devices. A statistical analysis is performed on the potentially matching pairs of datastreams in accordance with a statistical model in order to determine a likelihood that each of the potentially matching pairs of datastreams contain clickstream events from a common user.

### CROSS REFERENCE TO RELATED APPLICATION

This application claims the benefit of U.S. Provisional Application Ser. No. 62/010,704, filed Jun. 11, 2015, the contents of which are incorporated herein by reference.

### BACKGROUND

Marketers buy advertising across different media and it is important for them to obtain as complete a view as possible concerning its effectiveness. This applies not only to conventional mass media outlets such as broadcast television and print, but also to Internet advertising. This information can be used in an attempt to understand how to attribute the relative importance of the ad itself, the platform on which the ad is delivered and the context in which the ad is delivered. Among other uses, this information can allow advertisers to better target their ads. For example, advertisements are often presented on web pages and these advertisements may be viewed by the same user on different devices such as a desktop computer, a laptop, a smartphone and a tablet. However, it is currently difficult to determine whether the same user or different users are viewing an ad on a series of different devices.

Thus, it would be useful, for example, to be able to identify a desktop computer user and target that same user on a smartphone and/or a tablet.

### BRIEF DESCRIPTION OF THE DRAWINGS

FIG. 1 shows one example of an environment in which the systems and methods described herein may be employed.

FIG. 2 shows an environment in which advertisements are delivered to user devices by an ad server when they access a web page from the server of an online publisher.

FIG. 3 is a flowchart showing one example of method for tracking users across their various communication devices.

FIG. 4 shows two datastreams representing the sequence of clickstream events for two different communication devices.

FIG. 5 is a flowchart showing one example of how the Generalized Pair Hidden Markov Model (GPHMM) may be applied to the potentially matching pairs of datastreams that are obtained from two communication devices.

FIG. 6 shows two potentially matching datastreams that are each divided into three segments.

FIG. 7 shows clickstream events in the two potentially matching datastreams being combined into a single datastream chain.

FIG. 8 illustrates various components of an illustrative computing-based device.

### SUMMARY

In accordance with one aspect of the subject matter described herein, a method for determining a likelihood that two or more communication devices are associated with a common user is provided. In accordance with the method, clickstream data from a plurality of clickstream events is received from each of a plurality of communication devices in response to a web page being loaded by each of the communication devices. The clickstream events received from each communication device over a period of time are arranged into a datastream such that each of the datastreams contains clickstream events from only a single communication device. Based on the clickstream data in the clickstream events, potentially matching pairs of datastreams are identified that contain clickstream events from a common user using at least two different communication devices. A statistical analysis is performed on the potentially matching pairs of datastreams in accordance with a statistical model in order to determine a likelihood that each of the potentially matching pairs of datastreams contain clickstream events from a common user.

### DETAILED DESCRIPTION

In advertising products and services, advertisers have always had an interest in targeted advertising, that is to say finding a way of getting the advertising message to those who are actually potential customers, and not wasting effort and resources on those who have no need for or interest in the products or services. With the advent of personal computers connected to the Internet, and people retrieving information via the World Wide Web, such targeted advertising has become increasingly possible as compared to traditional broadcast media, public posters, etc. In addition to this, it has become possible to track to some degree, who actually takes an interest in the advertising message.

Internet advertising delivers promotional marketing to consumers. Internet display advertising is one particular example of internet advertising. Internet display advertising may include, for example, web banner ads, frame ads, pop-up ads, pop-under ads, floating ads, expanding ads, trick banners, interstitial ads, rich media ads, video ads, or text ads. Display ads may be served on desktop or laptop computers, mobile devices, or internet-connected appliances (such as televisions). Internet advertising revenue in general, and display advertising revenue in particular, is growing significantly each year.

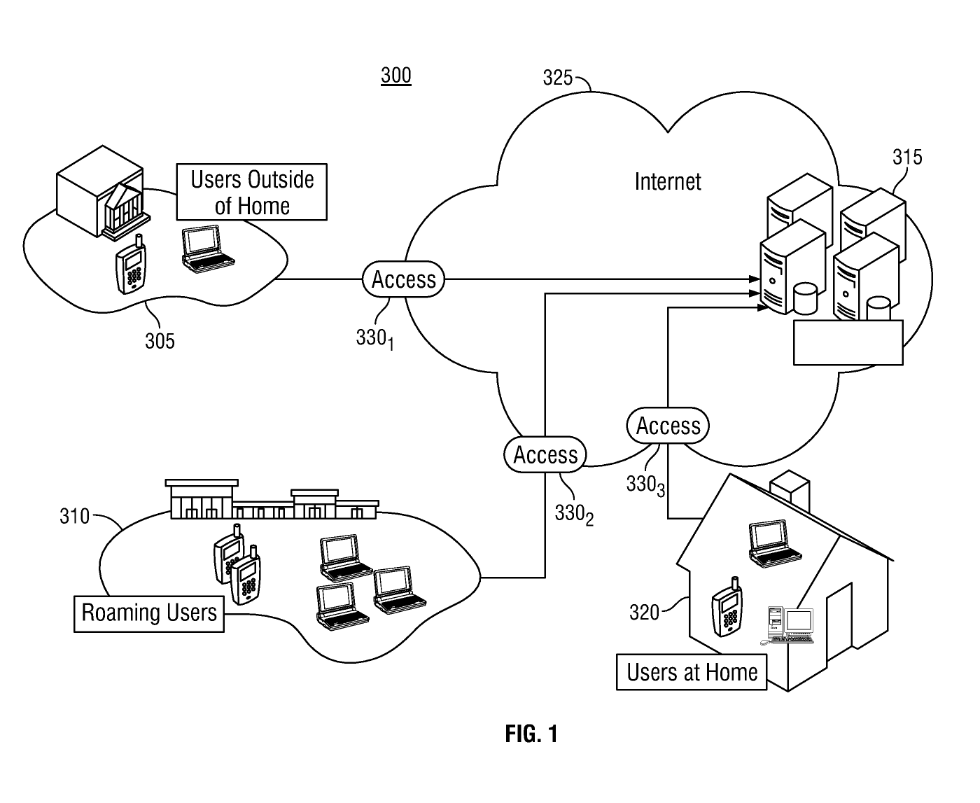

FIG. 1 shows one example of an environment 300 in which the systems and methods described herein may be employed. This example shows users establishing access, as indicated by reference numerals 330₁, 330₂, 330₃ . . . 330_{N} to one or more networks such as the Internet 325 in order to interact with cloud-based resources such as an online content provider or publisher that provides resources such as web pages, files, databases, libraries, and the like. Online content providers or publishers such as online content providers 315 often rely on Internet advertisements to fund much of the content they provide. The advertisers pay to have their advertisements displayed alongside and embedded within the online publisher's content.

FIG. 1 shows various users who may seek to access the cloud-based resources such as websites. Individual users may own and operate multiple connected devices simultaneously. For example, it is not uncommon for mobile users to have and use, in addition to a cell phone, other communication devices such as laptop computers, smartphones, tablets, and personal digital assistants (PDAs) and may travel among disparate networks with these devices. Users may also access communications using different devices at work and at home such as desktop computers, and may travel among disparate networks with these devices. For example, FIG. 1 shows users 320 who are at home using fixed and mobile devices such as PCs, laptops, and smartphones and roaming users 310 who may wish, for example, to surf the Internet to compare online pricing for a particular product while shopping at a shopping center. In addition, FIG. 1 also shows users 305 outside of the home such as students or employees who may be in an enterprise such as a school or workplace. Thus, as FIG. 1 demonstrates, any given user may use several different devices at multiple locations to communicate with online content providers or publishers.

Advertisements may be provided to users in various ways when they access a web page provided by an online publisher. In one simple example the ad servers are supplied by the content provider managing their own ad inventory, a third party that is building a library of available ad content or potentially even by the advertiser themselves. In this example the business model is usually direct between the content provider and the advertiser or third party aggregator of advertisers. Another example involves real time bidding processes that are established by ad exchanges who sell the advertising opportunity in an online auction.

Ad exchanges are technology platforms that facilitate bidding for the buying and selling of internet advertising from multiple ad networks, demand side platforms (called DSPs) and agency trading desks. These ad exchanges create a marketplace for advertisers to purchase display advertising, auctioning off each available spot for ads (called an impression) as it becomes available. One common method of implementing an internet advertising auction is for the advertiser to submit a bid through a bidding service provider (which may be an ad network, a DSP or an agency trading desk), which then passes a modified bid to an ad exchange. Thus, the advertisers compete for the advertising opportunity and the value is determined by how targeted the opportunity is and how much each advertiser is willing to pay for a certain level of targeting. The bidding process is completely automated by intelligent systems that use sophisticated algorithms to match the opportunity to the advertiser to maximize value for both the advertiser and the consumer. When the auction has closed, the winning bidder then has the right to serve the video ad from their video ad servers to the player.

Regardless of how the ad is served, information concerning the communication device on which it was served may be obtained in return by one or more parties such as the online publisher, the service provider operating the ad server, the ad exchange, the DSP, and so on. This information is obtained from the clickstream data that is received from the communication device's web browser when the ad is served. Clickstream data may include, by way of example, the IP address visited by the user, an entry page (the current web page being visited), a referrer page (the source page of the current page), the click time of the current page when the user visited, HTTP codes, HTTP traffic, HTTP response time, browser (or user agent) characteristics, a unique cookie ID of the visiting user, etc. Some or all of the clickstream data is sometimes also referred to as log impression data. The clickstream data received from a single device's web browser as a result of a single instance of an ad being served to the user device will be referred to herein as a clickstream event.

While clickstream data can provide useful information about the communication device (and hence the user of that device) on which an ad is served, it becomes difficult to target ads to users because, as discussed above, a user may employ many different devices at different locations to communicate with online publishers. For instance, a user A working at home on a laptop computer may be served an ad when communicating with a particular online publisher. Subsequently, this same user A, while commuting to work and using a smartphone, may once again by served an ad when receiving a web page from an online publisher on his or her smartphone. However, the clickstream data received from user A while working at home on his or her laptop computer will in all likelihood by different from the clickstream data received from user A while commuting and using his or her smartphone.

Attempts have been made to identify a user across multiple devices by examining online behavior patterns. For instance, in one simple example, user A, referred to above, may work on both the laptop computer and the smartphone while at home. While at home both devices may have the same IP address that is provided by the Wi-Fi router used in the household. This IP address will be available in the clickstream data received from both devices when used at home. Likewise, if user A takes the laptop computer and the smartphone to work, both devices will use the IP address that is provided by the firewall/proxy server used by the enterprise. Once again, this IP address will be available in the clickstream data received from both devices when they are used at the workplace. Given this particular behavior pattern, an interference can be made that the laptop computer and the smartphone are likely being used by the same person since both are used at the same household and the same workplace. Unfortunately, it is difficult to successfully perform this process of analyzing online behavior patterns for more complex situations where many more users and devices are involved.

As explained below, users of multiple devices can be tracked across their various devices using a statistical model that maps information describing a communication device that is obtained from clickstream data to the activity in which the user is involved at the time the clickstream data is generated. Any of a number of different statistical models may be employed, one example of which is the Generalized Pair Hidden Markov Model (GPHMM).

In the GPHMM, observed states are treated as a function of hidden states. In this case the observed states are represented by information that is available concerning the communication device at the time an instance of an advertisement is served. The hidden states are represented by the activity in which the user is involved when viewing the ad impression.

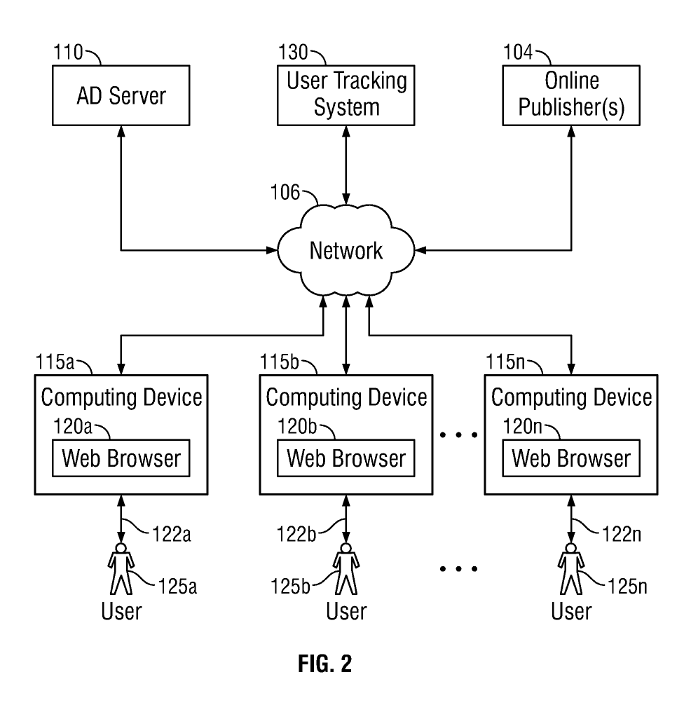

FIG. 2 shows an environment in which advertisements are delivered to user devices 115 by an ad server 110 when they access a web page from the server of an online publisher 104.

The user device 115a is representative of user devices 115a-115n and is a type of fixed or mobile communication device such as those discussed above in connection with FIG. 1. User devices 115a-115n (also referred collectively and individually herein as 115) are coupled to one or more networks represented by network 106, which may be, for example, the Internet. The user devices 115 communicate over network 106 to receive online advertisements from the ad server 110 and other content from publishing sites such as a server associated with online publishing server 104. The user devices 115 include a web browser 120a . . . 120n (also referred collectively and individually herein as 120) for presenting online content and advertisements to the user 125. The web browsers 120 present advertisements and other content, and receives input from the users 125a . . . 125n (also referred collectively and individually herein as 125). Among other things, the web browser 120 is configured to provide access to web pages hosted by online publisher 104. Although in FIG. 2 the users 125 are each illustratively shown using only a single user device 115, as discussed above more generally the users 120 may communicate with the various entities shown in FIG. 2 using a variety of different devices that can communicate over network 106.

In some embodiments the ad server 110 may be operated by the online publisher itself or by a third party, depending on the nature of the business arrangement employed between the ad server 110 and the online publisher 104. In other embodiments the online publisher 104 may be engaged in a real time bidding process in order to have ads served on its behalf. In this case the ad server 110 may be associated with other entities (not shown in FIG. 2) involved in an ad exchange such as real-time bidding systems, advertisement managing systems, market pricing systems, demand side platforms, and so. In such embodiments the ad server 104 is representative of many ad servers that participate in the bidding process.

FIG. 2 also shows a user tracking system 130 that tracks users 120 who are served ads across their multiple devices in accordance with the techniques described herein. User tracking system 130 may be operated by an independent entity or it may be associated with the ad server 110 or even the online publisher 104. In the context of a real-time bidding process, the user tracking system 130 may be affiliated with and/or operated by any of the entities involved in the ad exchange, such as the demand side platform, for example.

User tracking system 130 can receive clickstream data from user devices at various points in the process that is used to serve an ad to the users. In general when a user loads a web page an HTML markup is incorporated for any ads that are to be served along with the web page. The markup may be provided as part of the web page or, in the case of a real-time bidding system, the markup may be supplied by the winning bidder. In the latter case the web browser sends a request to the ad exchange to receive a markup from the winning bidder. In any case the HTML markup instructs the web browser 120 hosted by the user device 115 to request the ad from the ad server 110. The clickstream data is received when the web browser 120 interacts with the markup or when a request is sent by the web browser 120 to receive the markup from the winning bidder.

In some cases the data extracted from a clickstream event may include user agent data, which is a data string returned by the communication device when clicking on the ad impression. Various features may be derived from the user agent data such as a unique communication device ID, a communication device type and model and the operating system and browser being used by the communication device. In addition to features obtained from user agent data, the click stream events may include other data from which other features can be derived such as the date and time when the impression was served, the IP address of the communication device, the activity (e.g. viewing a web page of a newspaper, playing a video game, etc.) in which the user was engaged on the communication device at the time the impression was served, and, if available, the location (e.g., latitude and longitude) of the communication device when the impression was served. Other features may be obtained by examining changes that occur over two or more clickstream events. For instance, one feature may specify that a device's IP address has changed e.g., twice in the last three minutes.

Thus, in summary, a single click stream event is returned when an ad impression is served to a user. The event includes datapoints from which multiple features can be derived. This set of features obtained from a click stream event will be referred to herein as an “observed state” since the features collectively comprise a state of the communication device that is clearly visible. Accordingly, a single click stream event is associated with multiple features that represent a single observed state.

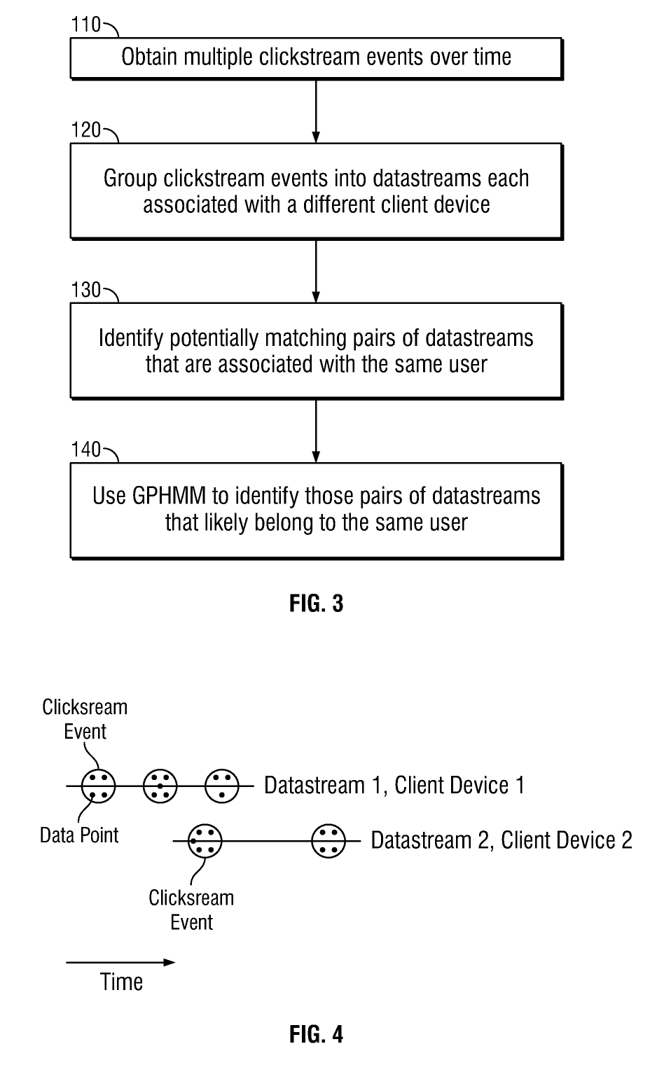

The use of log impression data to track users across their various communication devices will be explained below with reference to the flowchart shown in FIG. 3

First, in step 110 of FIG. 3 a sequence of clickstream events is obtained for multiple users over a period of time (e.g., minutes, hours, days). In step 120 the clickstream events are arranged into groups based on the communication device from which they were obtained (as determined by their unique communication device ID). The sequence of clickstream events obtained over time for a specific communication device is referred to herein as a datastream. For example, FIG. 4 shows two datastreams, one datastream representing the sequence of clickstream events for communication device 1 and the other datastream representing the sequence of clickstream events for communication device 2. As shown, each clickstream event comprises one or more datapoints.

Next, at step 130, potential matches between pairs of datastreams are determined. Two datastreams are said to match one another if they represent the same user who is using two different devices. The potential matches may be determined by comparing the features obtained from datastreams in any variety of ways, using, for example, a series of heuristics. For example, if features extracted from two datastreams indicate that at some point in time two devices shared the same IP address (indicating that they were on a common network), then the two datastreams may be potential matches. Likewise, if location information is available then two datastreams may be treated as potential matches if they were within a specified distance of one another (e.g., 5 miles) within a specified time interval (e.g. 20 minutes). Conversely, pairs of datastreams may be excluded as potential matches if their respective features indicate that they are unlikely to be associated with the same user. As a simple example, if there are two datastreams, each of which is associated with the same type of device (e.g., a mobile phone), the two datastreams are less likely to match than two datastreams that are each associated with different types of devices (since a given user is less likely to have two devices of the same type).

Once potentially matching pairs of datastreams have been identified, the process proceeds to step 140. In step 140 each pair of potentially matching datastreams undergoes statistical analysis to determine the likelihood that the datastreams are in fact associated with the same user. In one example, the statistical analysis employs a Generalized Pair Hidden Markov Model (GPHMM). That is, each of the aforementioned observed states that are derived from the clickstream events corresponds to one of the hidden states. For this purpose the hidden or underlying states may be thought of as representing different behavior patterns of users.

Although the statistical analysis may be mathematically conducted on the potentially matching pairs of datastreams without assigning actual patterns of behavior to user, it may be pedagogically useful to consider the relationship between the observed states and the underlying user behavior patterns that correspond to those observed states. To this end the following discussion will present one potential model that motivates the mathematical treatment that is performed on the features that constitute the observed states in the potentially matching pairs of datastreams.

In this model the hidden states are represented by the activity state in which the user was engaged at the time the ad impression was served and the clickstream data recorded. Examples of user activity states include, without limitation, eating breakfast, commuting to work and working. Of course, there are virtually an unlimited number of user activity states in which a user may be engaged while viewing an ad impression or otherwise generating the clickstream data. In practice, of course, only a limited number of user activity states (e.g., 10-500) are used for statistical analysis purposes.

A user's behavior pattern may be represented by a user's sequence of user activity states obtained over a period of time. For instance, one simplified sequence of user activity states may be as follows: eat breakfast at 7 am, commute to work from 7:30-8:15 am, work from 8:30 to noon, eat lunch from noon to 1 pm, continue working from 1 pm to 5 pm, and then commute home from 5 pm to 5:45 pm.

Each observed state extracted from a datastream can be associated with a user activity state (i.e., the hidden state). For example, if one feature in an observed state indicates that the device's IP address has changed over a relatively short period of time, the user's activity state is likely “commuting.” Further, if the device's IP address does not change over the next several observed states, the user may still be in the same commuting activity state because, for instance, the user may be on a train that is stopped at a station during this period of time.

Once a sequence of user activity states have been obtained for each datastream using the GPHMM, the sequences for each pair of potentially matching datastreams may be compared to determine the likelihood that they represent the same person. One way to accomplish this is to first predefine a number of “person profiles” that each represent a typical sequence of user activity states for a person based on their primary occupation. For example, person profiles may be developed in advance for students, teachers, suburban commuters, stay-at-home husbands or wives, retail workers, restaurant workers and so on. Individuals with these various occupations generally will have different schedules that will be reflected by different sequences of user activity states. Person profiles reflective of user behavior patterns may be based on other user characteristics or traits in addition to or instead of occupation such as age, gender, marital status, education and interests, for instance.

After obtaining the sequence of user activity states for each pair of potentially matching datastreams each sequence is compared to each of the predefined person profiles to determine the likelihood in each case that the two datastreams correspond to the same person profile. As discussed above, the user activity states for each pair of potentially matching datastreams correspond to the hidden states that may be determined from the observed states using the GPHMM discussed above. If the two datastreams match a single one of the predefined person profiles with a sufficiently high probability, the two datastreams may be treated as belonging to the same person.

When the statistical model is applied to the data, the activity states and the person profiles do not need to be specifically identified by a name that represents actual activities in which users are involved and profiles of actual people. Rather, activity states and person profiles may be assigned index numbers, with the number of indices assigned in each case being tunable parameters that can be adjusted up or down depending on the nature of the clickstream data that is available.

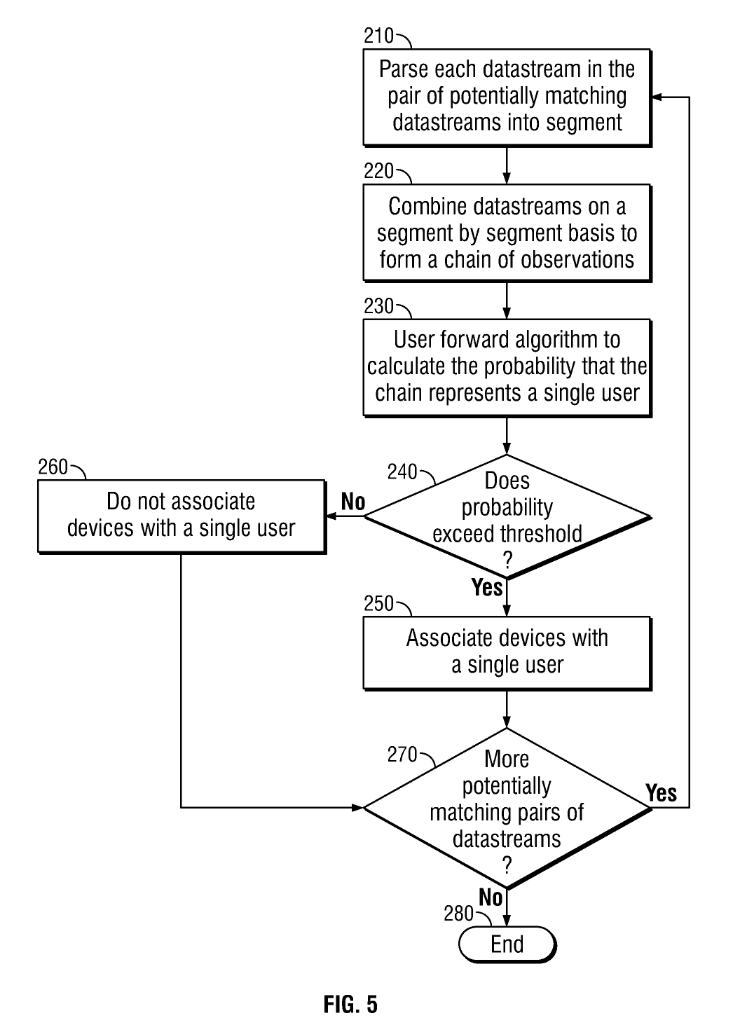

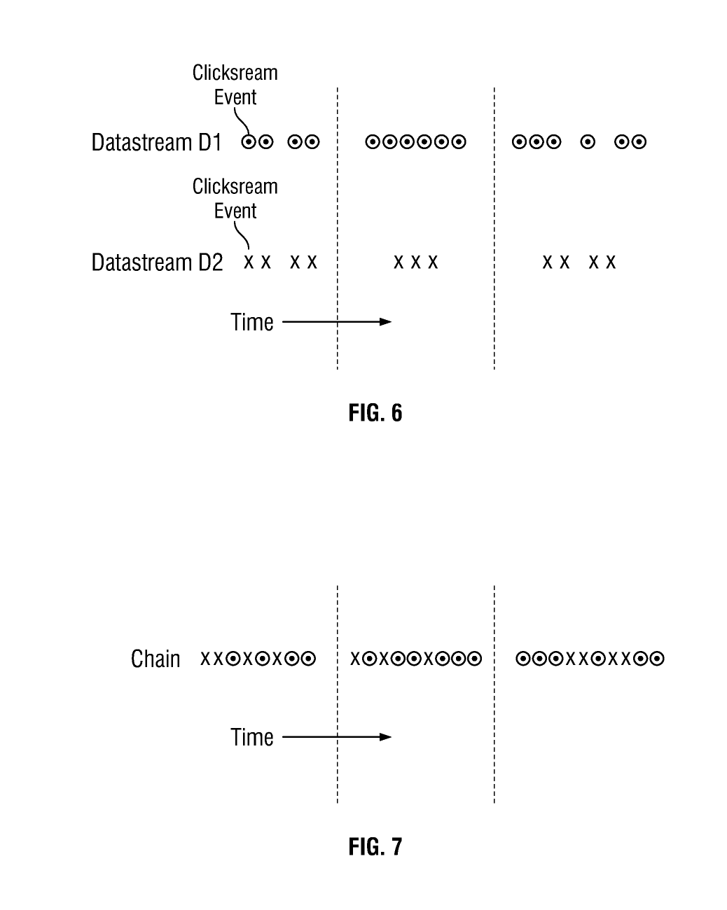

FIG. 5 is a flowchart showing one example of how the GPHMM may be applied to the potentially matching pairs of datastreams that are obtained from two communication devices. First, in step 210 each datastream is partitioned into segments that are divided by an extended time period during which no clickstream events are obtained. These time periods generally (though not always) occur overnight when users are sleeping. For simplicity, the segments may be divided into segments at preselected time of day such as midnight or 1 AM, for example. FIG. 6 shows two potentially matching datastreams D1 and D2 that are each divided into three segments, as indicated by the dashed vertical lines. Each segment includes clickstream events that have occurred over the duration of the segment. Next, at step 220, the clickstream events in the two datastreams D1 and D2 are combined into a single datastream chain. Specifically, the datastreams D1 and D2 are combined on a segment by segment basis. As shown in FIG. 7 the clickstream events in datastreams D1 and D2 obtained from two potentially matching communication devices are distributed along a single chain. The segments associated with the chain (which are formed from the combination of the individual segments of the two datastreams) are referred to herein as an observation. Accordingly, the chain comprises a series of observations that are respectively co-extensive with the duration of the segments in the individual datastreams D1 and D2.

Next at step 230 in the flowchart of FIG. 5, in the context of the hidden Markov model, the forward algorithm is used to calculate the probability of various potential hidden states to obtain the probability that the chain represents a single user. The resulting probability is compared to a threshold probability in decision step 240. The threshold probability is a minimum probability above which the two devices from which the datastreams D1 and D2 are obtained will be treated as being associated with a single user. This threshold may vary from application to application so that in some cases, for example, a 51%, 75% or 85% probability will be sufficient to treat the two devices as belonging to a single user.

If at step 240 the threshold is exceeded, the two devices are associated with a single user in step 250, otherwise they are not associated with a single user in step 260. In either case the process proceeds to decision step 270, in which it is determined if there are any additional potentially matching pairs of datastreams to be examined. If so, the process returns to step 210, otherwise it ends at step 280.

The model described above may be validated using a known set of data. Such a set of data may be carrier specific data that is obtained from network operators and the like. The data presents a dataset of known users to better tailor the model and assess its accuracy. In particular, a training process may be employed using the known set of data to determine the probability that a user with a particular person profile is in a certain underlying state and the probability of transitioning from that underlying state to some other underlying state. The training process may also be used to determine the probability of transitioning from one observed state to another observed state.

In the discussion above the clickstream data that is used to develop the datastreams is obtained in the context of serving an ad. More generally, however, this information may be obtained in other contexts as well. For example, this information may be obtained whenever a user accesses a web page by, for example, placing a transparent pixel on a web page, which causes the communication device's browser to report information similar to that found in the user's clickstream data.

The results obtained from the GPHMM may be valuable to advertisers, marketers and others. For example, the results can be used to determine how many unique users have viewed an ad, the platforms on which the ads are viewed, the web sites on which the ad is viewed, how many times an ad is viewed by a particular user before clicking on it, and what users are doing when viewing an ad. In this way advertisers can better contextualize the manner in which their advertisements are being viewed. The results can be used by advertisers, for example, to retarget their ads across different communication devices as well as for quick conversion attribution to identify which ads are most effective. In addition, the results can be used to facilitate sequential advertising to ensure that a series of ads are viewed in their proper sequence.

### Illustrative Computing Environment

Aspects of the subject matter described herein are operational with numerous general purpose or special purpose computing system environments or configurations. Examples of well-known computing systems, environments, or configurations that may be suitable for use with aspects of the subject matter described herein comprise personal computers, server computers, hand-held or laptop devices, multiprocessor systems, microcontroller-based systems, programmable consumer electronics, network PCs, minicomputers, mainframe computers, personal digital assistants (PDAs), gaming devices, appliances including set-top, media center, or other appliances, automobile-embedded or attached computing devices, other mobile devices, distributed computing environments that include any of the above systems or devices, and the like.

Aspects of the subject matter described herein may be described in the general context of computer-executable instructions, such as program modules or components, being executed by a computer. Generally, program modules or components include routines, programs, objects, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

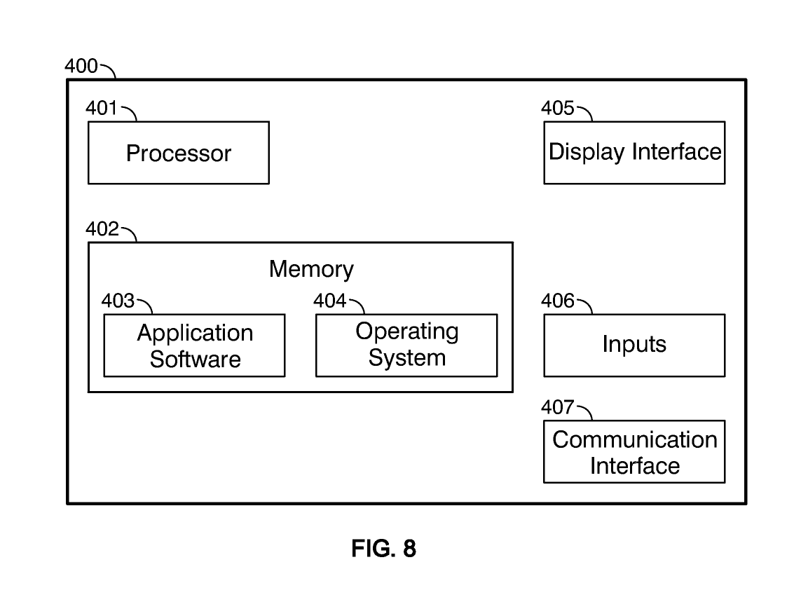

FIG. 8 illustrates various components of an illustrative computing-based device 400 which may be implemented as any form of a computing and/or electronic device, and in which embodiments of a user tracking system, online publisher, ad server and/or a communication device as described above may be implemented.

The computing-based device 400 comprises one or more inputs 406 which are of any suitable type for receiving media content, Internet Protocol (IP) input, activity tags, activity state information, resources or other input. The device also comprises communication interface 407 to enable the device to communicate with one or more other entity using any suitable communications medium.

Computing-based device 400 also comprises one or more processors 401 that may be microprocessors, controllers or any other suitable type of processors for processing computing executable instructions to control the operation of the device in order to provide a search augmentation system. Platform software comprising an operating system 404 or any other suitable platform software may be provided at the computing-based device to enable application software 403 to be executed on the device.

The computer executable instructions may be provided using any computer-readable media, such as memory 402. The memory is of any suitable non-transitory type such as random access memory (RAM), a disk storage device of any type such as a magnetic or optical storage device, a hard disk drive, or a CD, DVD or other disc drive. Flash memory, EPROM or EEPROM may also be used.

An output is also provided such as an audio and/or video output to a display system integral with or in communication with the computing-based device. A display interface 405 is provided to control a display device to be used in conjunction with the computing device. The display system may provide a graphical user interface, or other user interface of any suitable type.

1. A method for determining a likelihood that two or more communication devices are associated with a common user, comprising:
receiving clickstream data from a plurality of clickstream events from each of a plurality of communication devices in response to a web page being loaded by each of the communication devices;
arranging the clickstream events received from each communication device over a period of time into a datastream such that each of the datastreams contains clickstream events from only a single communication device;
based on the clickstream data in the clickstream events, identifying potentially matching pairs of datastreams that contain clickstream events from a common user using at least two different communication devices; and
performing a statistical analysis on the potentially matching pairs of datastreams in accordance with a statistical model in order to determine a likelihood that each of the potentially matching pairs of datastreams contain clickstream events from a common user.

2. The method of claim 1 wherein the plurality of clickstream events is received in response to an advertisement being served to the communication devices.

3. The method of claim 1 wherein the statistical model is a hidden Markov model.

4. The method of claim 1 wherein identifying potentially matching pairs of datastreams includes identifying potentially matching pairs of datastreams by performing a heuristics analysis.

5. The method of claim 1 wherein identifying potentially matching pairs of datastreams includes identifying a pair of datastreams as potentially matching if they each include at least one clickstream event with a feature representing a common IP address.

6. The method of claim 1 wherein identifying potentially matching pairs of datastreams includes identifying a pair of datastreams as potentially matching if they each include clickstream events having features indicating that the two different communication devices were within a specified distance of one another with a specified period of time.

7. The method of claim 1 further comprising excluding a pair of datastreams as being potentially matching pairs of datastreams if they contain clickstream events with features indicating that the two different communication devices are of the same type.

8. The method of claim 1 further comprising obtaining observed states from features in the clickstream events for use in the hidden Markov model.

9. The method of claim 8 wherein the hidden Markov model includes hidden states that represent different behavior patterns of users.

10. The method of claim 9 wherein each of the different behavior patterns represent a sequence of user activity states in which a user is engaged when generating the clickstream events.

11. The method of claim 10 further comprising associating user activity states with the observed states obtained from the features in the clickstream events.

12. The method of claim 1 further comprising causing an ad to be served to each of the communication devices, the ad being presented on the web page loaded by each of the communication devices, wherein receiving the clickstream data includes receiving clickstream data that is generated when a user clicks on the ad.

13. The method of claim 1 wherein the clickstream data includes user agent data that describes one or more characteristics of the communication device from which it is received.

14. The method of claim 1 wherein the clickstream data for one or more of the clickstream events includes an IP address of the communication device from which the clickstream data is received, an activity in which a user of the communication the user is engaged on the communication device when the clickstream data is generated and a location of the communication device when the clickstream data is generated.

15. A user tracking system, comprising:
a communication interface for receiving clickstream data from a plurality of clickstream events from each of a plurality of communication devices; and
a processor configured to (i) map information obtained from the clickstream data to a corresponding second state using a statistical model and (ii) based on the mapping, determine that two or more of the communication devices are likely associated with a common user.

16. The user tracking system of claim 15 wherein the statistical model is a hidden Markov model and the first state is an observed state and the second state is a hidden state.
